(19) United States
(12) Patent Application Publication
(10) Pub. No.: US 2024/0268423 A1
(43) Pub. Date: Aug. 15, 2024

(54) PLANAR SAUSAGE AND MANUFACTURE OF SAME

(71) Applicant: The Flat Dog, LLP, Cleveland Heights, OH (US)

(72) Inventors: Martin A. SALA, Theresa, NY (US); Moshe MANN, Cleveland Heights, OH (US)

(73) Assignee: The Flat Dog, LLP, Cleveland Heights, OH (US)

(21) Appl. No.: 18/643,396

(22) Filed: Apr. 23, 2024

Related U.S. Application Data
(63) Continuation of application No. 17/734,853, filed on May 2, 2022.

(51) Int. Cl. A23L 13/60; A22C 7/00; A22C 11/00; A22C 13/00; A23B 4/044; A23P 30/25

(52) U.S. Cl. CPC A23L 13/65; A22C 7/0023; A22C 11/00; A22C 13/0003; A23B 4/044; A23P 30/25; A22C 2013/0023

(57) ABSTRACT

An improved process for the manufacturing of emulsion-type sausages into a flattened form-factor that does not require the use of individual molds.

### RELATED APPLICATION

This application claims priority to U.S. patent application Ser. No. 17/734,853, filed on May 2, 2022, and titled “PLANAR SAUSAGE AND MANUFACTURE OF SAME,” the entirety of which is incorporated herein by reference.

### BACKGROUND OF THE INVENTION

The literature suggestsⁱ that a cylindrical sausage, such as a hotdog, poses a significant choking hazard, especially for children younger than Grade IV because the child may bite-off more than a safe amount. There are no hot-dog alternatives available to school children in a market that exceeds $2.5B sales in 2013ⁱⁱ. A planar sausage drastically reduces the danger of choking by offering a thinner cross-section yet maintains a form-factor that is not lost within the bun. This product is amenable to mass production and suggests a wealth of other advantages yielding a huge market opportunity.

### SUMMARY OF THE INVENTION

Embodiments of the invention relate to a substantially flat sausage and a means to manufacture a sausage having a flat form-factor.

The planar form factor also lends itself to a plurality of other advantages including stability of the product on the substrate (i.e.: a hotdog bun); the ability to introduce grooves aiding in retaining applied condiments; elimination of the “trough-shaped bun” (the hotdog roll) and the roll's fragile seam; a form-factor that completely covers the standard-shaped hotdog bun.

For the purpose of this document, the term Flat-Dog shall mean any of various sausage products that are produced in a flatted form-factor. It will be understood that a Flat-Dog may be any of, but not limited to substantially flatted meat-based or plant-based sausage-food-products, such as Dachshunds, Kosher-hotdogs, hotdogs, hot_dog (in some spellings), wieners, frankfurters, franks, tube-steaks, Georgia hots, boasters, Coneys, crowd-pleasers, dogs, flaunters, foot-longs, grandstanders, red-hots, showboats, weenies, or sausages. The end-product sandwich will be referred to as a hot-dog-sandwich.

As stated, sausages, especially those comprising the hot dog, constitute a choking hazard as documented by numerous groupsⁱⁱⁱ because of the cylindrical form-factor and the perfect cross-section diameter of a bitten-off piece to occlude a child's airway. If a hotdog were manufactured as a flattened form-factor, an individual's bite (or bolus) would of necessity grab a thinner cross-section of meat, thereby reducing the probability of choking hazard for the most vulnerable: children and the elderly. The patent literature also describes the choking issue in adults (U.S. Pat. No. 5,069,914). This is dramatically illustrated in the Kevin Costner film Field of Dreams when a child chokes on a hotdog at a ball game, to be rescued by Dr. Archibald ‘Moonlight’ Graham.

It is, thus, an object of the invention to provide a sausage having a flattened form-factor to reduce the choking hazard.

It is another object of the invention to provide process and machinery to manufacture a flattened sausage. It is still another object of the invention to provide manufacturing machinery and processes for manufacturing sausages that can be inserted or integrated into existing production lines to transform cylindrical hot dogs to Flat Dogs with minimal process change. It is a further object of the invention to provide machinery and a method of manufacturing that improves product flow whilst reducing energy consumption by the inclusion of shape fixing means, prior to cooking.

It is still another object of the invention to provide a flat sausage having one or more furrows or arbitrary grooves to aid in retaining condiments. In this regard, condiments placed on hotdogs of the prior art cylindrical sausages tend to fall off the hotdog with some remaining on the bun or to ooze out of an end squarely on to one's clean white garment. The furrows can be oriented in any of various directions and they may assume any of various depths and/or geometries in different embodiments of the invention. It will be understood that the furrows could take the form of a trademark or name, or characters lending to both form and function. These furrows, or through-holes, are known as the Condiment-Keeper.

The Condiment Keepers, by virtue of function, transform a piece of food in to a tool. This functionality is also applicable to a cylindrical or tubular hotdog by a lumen which traverses the length of the hotdog allowing it to be filled from one or either end. Cylindrical cheese (as a cheese-stick) or a meat-stick may be inserted providing further gastronomic delight. This applicable to any cylindrical meat-stick prefilled with a condiment.

It is another object of the invention to provide a substantially flat sausage having one or more grooves that are defined by surrounding walls—thus maintaining condiments within the confines of the sausage. When the sandwich is perpendicular to one's lap, the condiments are inhibited from leaking onto one's lap.

A yet another object of the invention to provide a flat sausage such that when in combination the bound-edge of a bun said edge is not required for the retaining the hotdog for sandwich-style eating; with the use of Condiment-Keepers provides a rough “ball and socket means” to hold the flat-dog firmly within the bun-sides. When the seam fails, the hot-dog will not fall into one's lap.

It is still another object of the invention to provide a substantially flat sausage having one or more holes placed on to/into one face thereof, or having one or more holes tunnel through the entire thickness thereof. In embodiments of the invention, the holes assist in quicker cooking and for permeation of the condiments. Additionally or alternatively, the Flat-Dog may be provided with a plurality of small perforations in the surface to enhance the “crunch” post cooking over the appropriate heat-source.

It is an object of the invention to provide a substantially flat sausage that is stackable such that multiple Flat-Dogs may be placed atop each other as hamburgers are in the fast-food industry^{iv} It is an object of the invention to provide a flattened form-factor hotdog that is either skinned (batter confined by a casing) or non-skinned (no casing). For example, skinned Flat-Dogs are produced by any one of filling a preformed casing, filling and shaping a casing of suitable geometry, or using a master-sausage which is divided into a multiplicity of Flat-Dogs. Flat-Dogs may be coëxtruded using suitable materials or the casing material included in the batter mix. Alternatively, a skin or casing may be chemically applied to the formed hot-dog.

Yet another object is that a Kosher casing for use in hot dogs is expensive. By using the coëxtrusion casing-means of the invention, Kosher hot-dogs will now be able to be manufactured with Snap! or Pop! further enhancing the eating experience.

In still another object of the invention, a skinless Flat-Dog is manufactured concurrently with the packaging thus providing the forming, eliminating the bulk-packaging step and providing single-use convenience. This packaging is receptive to shelf-stable processing.

In the above embodiment of the invention, it is desirable for Flat-Dogs to be sequentially produced on an assembly line at a typical rate that may exceed 500/minute. This precludes the use of forms or molds as described in U.S. Pat. No. 3,857,330 that must be filled, processed and emptied. It is suggested that the reader view: How It's Made: Hotdogs^{v}.

### DETAILED DESCRIPTION OF THE INVENTION

Embodiments of the present invention will now be described with reference to the above-identified figures. The drawings and descriptions herein of the invention are not intended to limit the scope of the invention. It will be understood that various modifications of the present description of the invention are possible without departing from the spirit of the invention. Also, features or steps described herein may be omitted, additional steps or features may be included, and/or features or steps described herein may be combined in a manner different from the specific combinations recited herein without departing from the spirit of the invention, all as understood by those of skill in the art.

Dimensions given are given as a reference to scale and are not to be considered an absolute.

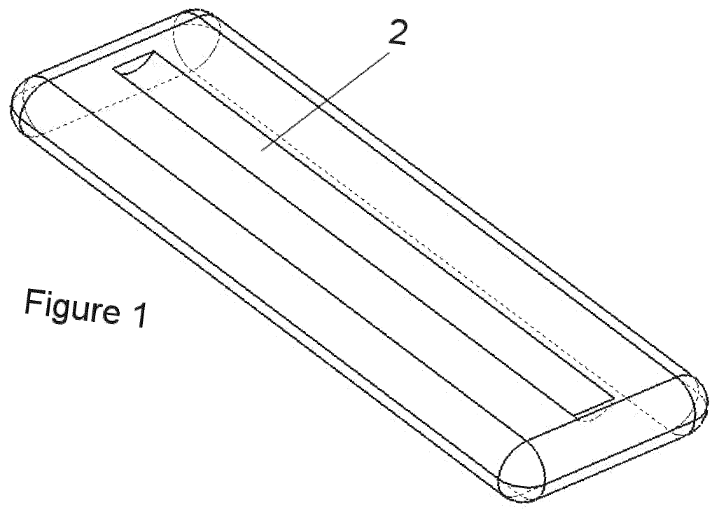

FIG. 1 is a top perspective view of a Flatdog having a slot 2 on its upper surface according to an embodiment of the invention. The slot 2 is an indentation of similar groove made in the upper aspect of the Flatdog to serve as a reservoir for condiments—i.e. a “condiment keeper.” It will be understood by those of ordinary skill in the art that a condiment keeper may be formed of any of different sized and shape grooves, channels or other indentations. It will be appreciated by those of ordinary skill in the art that any groove or similar slot configured to receive and substantially maintain a condiment therein are within the teaching of the invention.

In embodiments of the invention, the slot 2 or condiment keeper is formed of a channel having a floor surface that is surrounded by walls. The surrounding walls maintain the condiment within the confines of the Flatdog—such that the condiment keeper does not create a conduit for allowing condiment to run off the Flatdog.

It will be further understood by those of skill in the art that slot 2 may be formed of an opening that traverses the thickness of a Flatdog.

Thus, a Flatdog having at least one slot or other condiment keeper achieves several advantages. For instance, the product is safer for children due to its low profile. In addition, its flat aspect provides it with stability when placed in a bun or similar bread product. Still further, the condiment keeper allows for a neater eating experience as condiments are substantially maintained within the perimeter of the Flatdog.

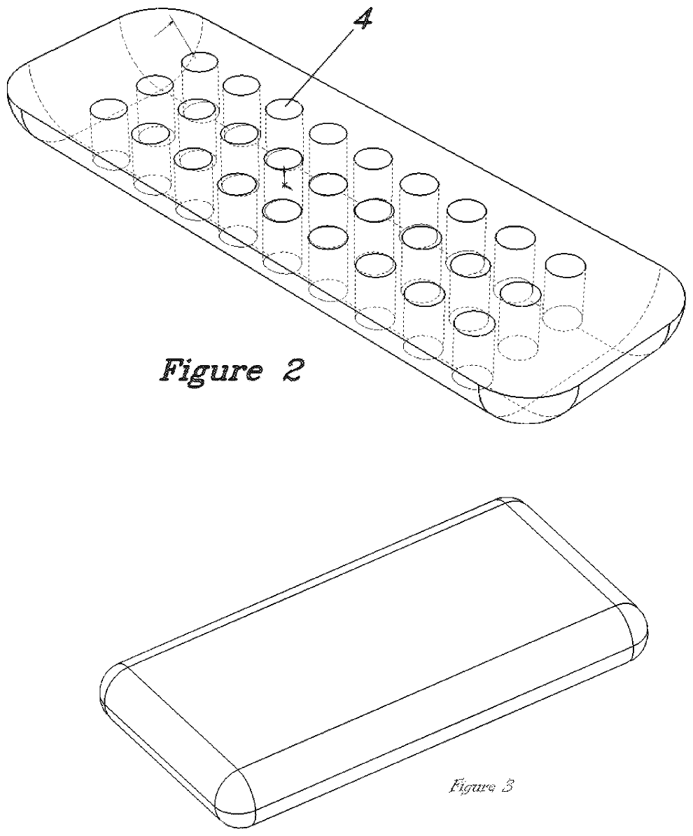

FIG. 2 depicts a planar Flatdog with a multiplicity of holes according to an embodiment of the invention. One or more holes 4 that traverse the thickness of the Flatdog allows for both retention of a condiment and enhanced cooking attributes. By having through holes 4, heat from a grill or forced air will be allowed to permeate the interior expediting the cooking process.

The bun-material would impinge upon the holes slightly, aiding in retention of the sausage product.

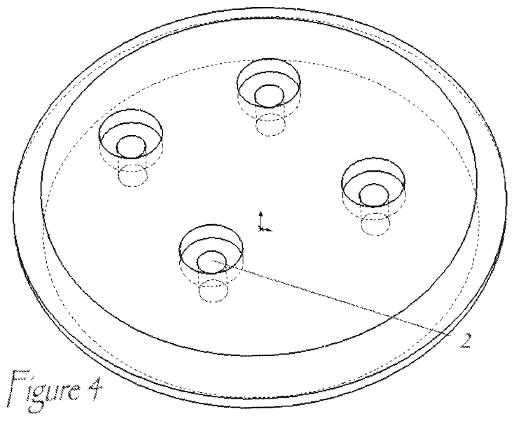

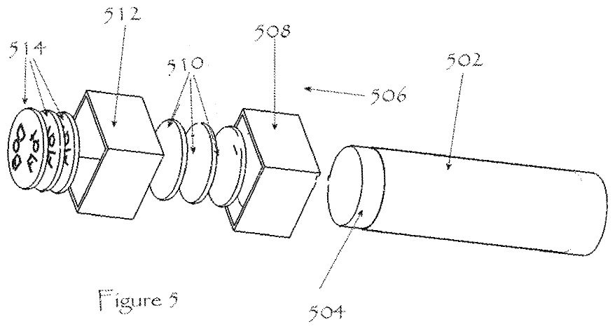

FIG. 3 shows a planar form-factor Flatdog according to an embodiment of the invention.

FIG. 4 shows a circular Flatdog according to an embodiment of the invention. As shown, one or more through holes are provided as Condiment-Keepers and/or means to facilitate quicker cooking.

It will be understood that Flatdogs may be manufactured according to any of various manufacturing process.

For example, FIG. 5 shows a schematic view of a manufacturing system whereby a sausage-blank is used to form Flatdogs according to embodiments of the invention. In the embodiment shown, a blank 504 comprising a block of meat-based or plant-based sausage material having a cross-sectional shape of a flat-dog is produced by any of various means know in the art. In an embodiment of the invention, blank 504 is optionally encased in a casing 502. The arrow indicated by reference numeral 506 indicates the direction of production, whereby 508 is a slicing device that cuts a segment off of blank 504 to yield a Flatdog. Groove maker station 512 applies the condiment keeper, if not already applied. Groove maker station 512 may be a shaping die to stamp a condiment keeper into the Flatdog or it may be a blade, router or similar cutting mechanism used to cut away sausage material to form a condiment keeper.

512 may also be used to apply a casing to the circular Flat Dogs 510, without which, the Flat Dog would be little more than a slab of bologna.

FIG. 5 shows three circular Flat-Dogs 514 with condiment keeper grooves in the shape of the words “Flat Dog” having been formed in accordance with this embodiment of the invention.

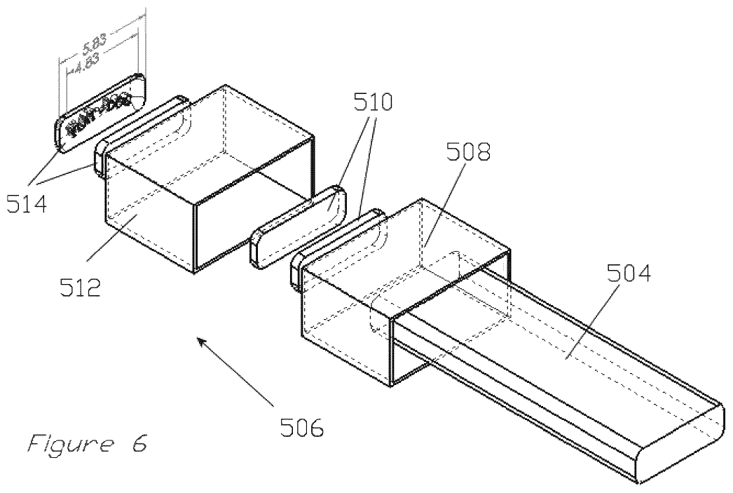

FIG. 6—Another model of manufacturing system similar to that described with reference to FIG. 5, save that the form-factor of the blank is changed from circular to rectanguloid. Using material of Spam-like form and function could convert into a Flat-Dog. Casing would be added in 512. Hotdog Batter is the preferred filling.

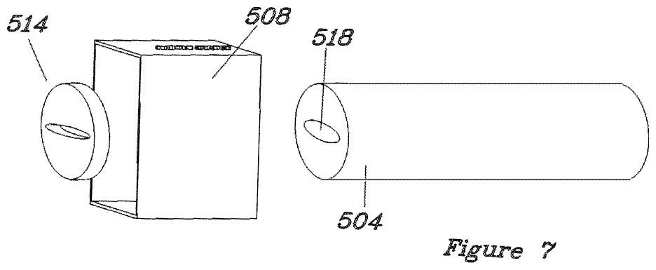

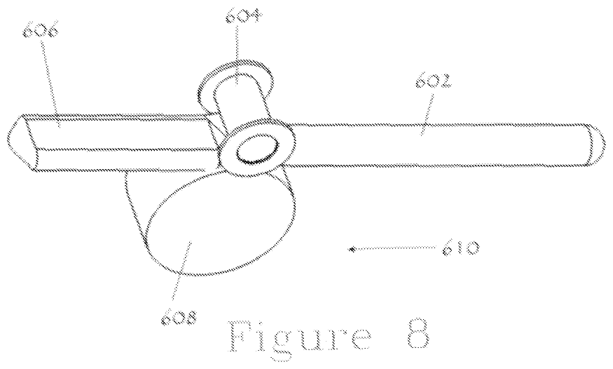

FIG. 7—An exemplary manufacturing system similar to that described with reference to FIG. 5, except here a Condiment Keeper is formed in situ within the blank, thereby dispensing with the post forming step to impart a Condiment Keeper. As shown, a blank 504 is formed with one or more slots 518 that span a longitudinal aspect of the blank. Thus, when the blank is subsequently sliced to form Flatdogs, the interior slot serves as a condiment keeper that spans the thickness of the Flatdog. 508 would provide application of casing, if desired.

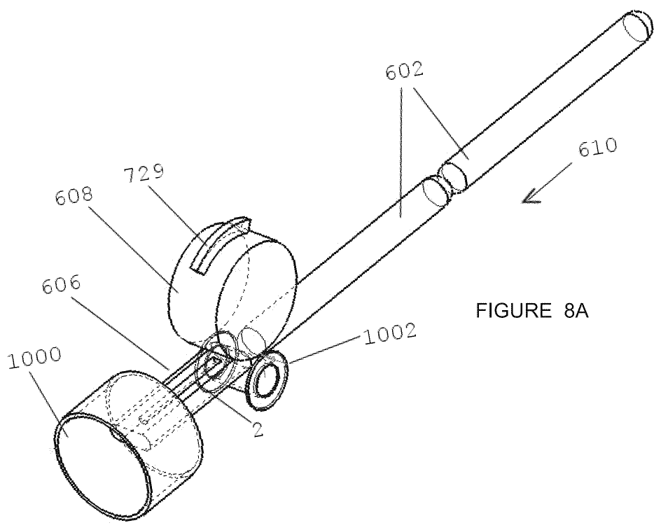

FIG. 8—A schematic view of an in-process system used to convert a standard hotdog production line into a Flatdog line according to an embodiment of the invention. As shown, a cylindrical hotdog 602 known In the art is modified after the casing has been filled, but not cooked or, if required, smoked. In accordance with an embodiment of the invention, a roller 604 is used to impart the shape of the Flatdog by passing the cylindrical hotdog through a squeeze formed by the internal contour of roller 604 and idler 608 (either controlled or not), to maintain appropriate pressure on the sausage normal to 604. A tubesteak 602 is shown entering the squeeze, whereas a flattened segment 606 is the original tubesteak 602 having been flattened and converted to a Flatdog. The arrow identified by numeral 610 represents the direction of the process. In an embodiment of the invention, roller 608 is provided with a heat source, such as an electronic heating element or a microwave source to provide heat for simultaneous flattening and cooking of the Flatdog.

FIG. 8a—A schematic view of an in process system as disclosed in FIG. 8 whereby an existing production line may be configured to convert a cylindrical frankfurter into a Flatdog. As described, cylindrical raw hotdogs 602 are flatted and simultaneously cooked to solidify the flattened shape. In the embodiment shown, a drum 608 is provided with a raised segment on a portion of its annular edge. The raised segment (e.g. Condiment Keeper former 729) bores into the raw hot dog material to impart a condiment keeper groove. It will be understood by those of ordinary skill in the art that Condiment Keeper former 729 is sized and shaped to apply a groove along only a limited section of the longitudinal axis of a Flatdog such that the groove remains bounded on all sided. Drum is synchronized to rotate and apply the condiment keeper groove at the desired section of the Flatdog.

It will be understood that embodiments of the invention set forth in FIGS. 8 and 8a may be used to form Flatdog with or without casing. To form Flatdogs without a case, the forming structures may be rotated by 90° to facilitate a gravity-feeding of unbounded sausage material. Cylindrical hotdogs without casing could also be partially frozen to provide structural integrity. The motion is in the direction of arrow 610 (or downward in the case of a gravity-fed system.

It will be understood by those of ordinary skill in the art that Condiment Keeper former 729 may be a die, or a punch or router as described earlier. If working with uncooked hotdog meat, it would be a die and may be heated to partially cook the material aiding in retaining the form of the Condiment Keeper 2. It may also be a microwave radiator achieving the same goal. Drive 1002 keeps the cylindrical hotdog in contact with the forming means 608/729. In this embodiment, the Condiment Keeper former 729 is curved to reflect the forming means. Flatdog 606 emerges from the process and proceeds to 1000 for further cooking, smoking or processing. This process is continuous.

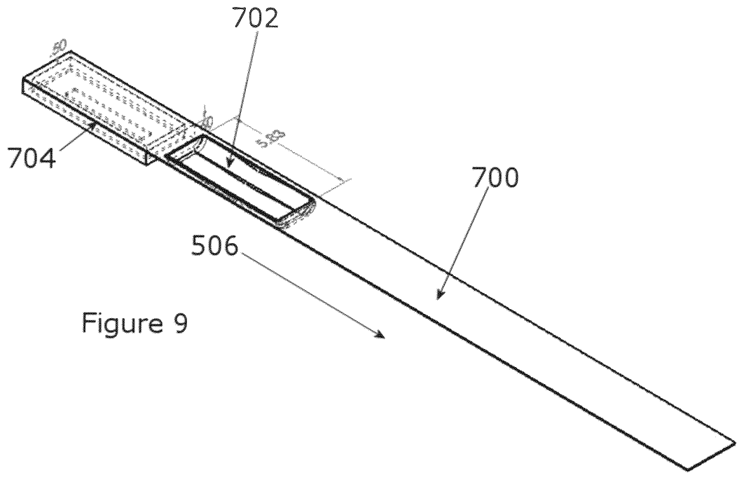

FIG. 9—A schematic view of a manufacturing system for forming a Flat-Dog in the same package that it is sold. In this embodiment, the Flat-Dog manufacturing machinery is configured to form, cook, and package Flatdogs for single use sales and also be a component of a Shelf Stable process. The process of forming a Flatdog begins with an elongated plastic tape that is formed into a pocket by a forming die. Next, sausage material is poured into the plastic pocket. The pocket is subsequently sealed and with an upper plastic tape. The Flatdog is preferably cooked while in the plastic pocket. In embodiments of the invention, an elongated sag is formed in the floor of the pocket that is substantially sized and shaped to receive a forming die used to form a condiment keeper groove. The sag provides an area in which the plastic pocket may be pushed inward without the risk of tearing.

In the exemplary embodiment shown, a tape 700 is shown moving in the direction of arrow 506. Thus, in the orientation shown, tape 700 originates from the top left of the page and proceeds toward the right side. At an initial step, tape 700 is drawn over a forming die 704. Forming die 704 is used to produce a pocket 702 in tape 700 as described in more detail below.

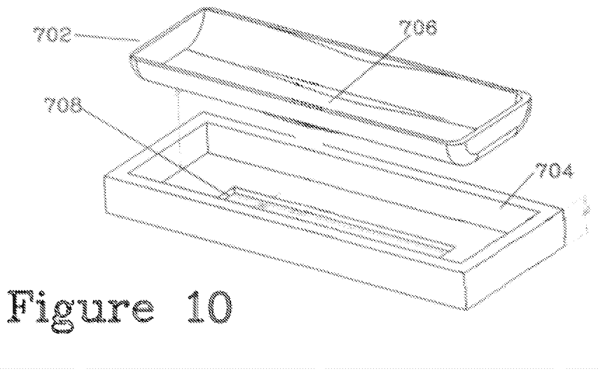

FIG. 10 is an enlarged view of a forming die 704 and a plastic pocket 702 that was formed thereby. A sag 706 is shown along the bottom surface of the pocket.

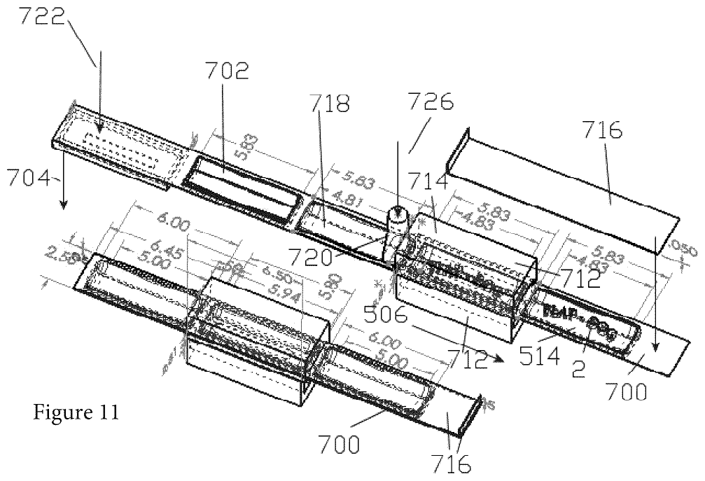

FIG. 11 shows an exemplary production process for manufacturing a Flat-Dog as part of an exclusive of a forming machine. The process proceeds in the direction of the arrow 506. Beginning at the top of the page raw tape passes over the forming die 704. Forming die 704 is substantially a negative shape of a pocket to be formed with a narrow groove 708 in its lower surface. Groove 708 forms the sag 706 on the undersurface of the pocket 702. Once a section of tape 700 is disposed above forming die 704 a potential pressure 722 or a pulling means is applied to draw tape 700 into the die in order to create the pocket 702. It will be understood that potential pressure 722 may include vacuum pressure, air pressure, or a combination of both. At the next step, raw hotdog meat or similar batter is poured into pocket 702 with applicator 720. Just after pocket 702 is filled, cover tape 716 is applied to the bottom tape 700 and is sealed at the final forming step whereby an interface formed by an upper die 714 (microwaving or other cooking means) and a condiment keeper former 712 are pressed together to, both, heat the Flat-Dog and form the condiment keeper.

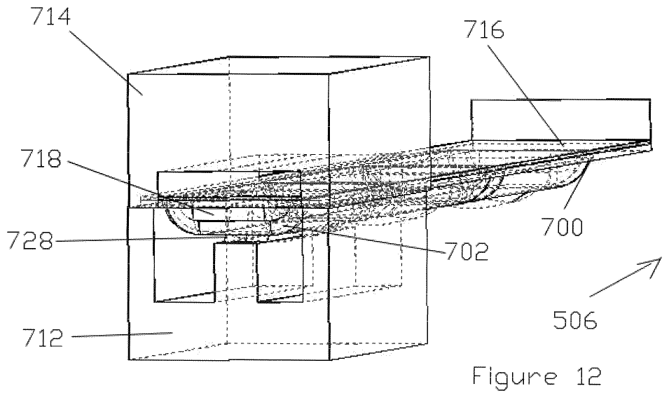

FIG. 12 shows a rear view of interfacing members used in the final forming step. As shown, upper die 714 has a substantially flat inner profile that passes over the top of the Flat-Dog sitting in the pocket 702. Lower, condiment keeper die 728 is pushed into the sag area of 702 and into the raw hotdog meat which is then exposed to either microwaves or some other heating means (not limited to ultrasound, nuclear radiation, steam, or other heat source). As described, because of the sag 706 previously imparted to the pocket, a small amount of plastic film is drawn into the Flat-Dog material when the lower condiment keeper die 728 is applied. Thus, the condiment keeper groove is applied without tearing or distorting the shape of the Flat-Dog pocket 702.

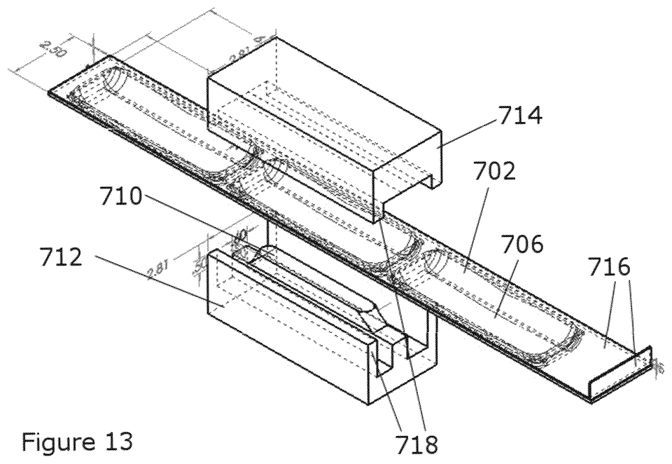

FIG. 13 is an exploded view of the condiment keeper press and the heating/cooking unit. Edges 718 on units 714 and 712 may be used to seal the top tape to the bottom tape, (e.g. via sealing common in the Art of packaging machines). Condiment keeper die 710 may need to have a flexible or adjustable or controllable interface with the mounting block to compensate for differences in raw hotdog meat consistency. This detection of this consistency is accomplished elsewhere in the machine.

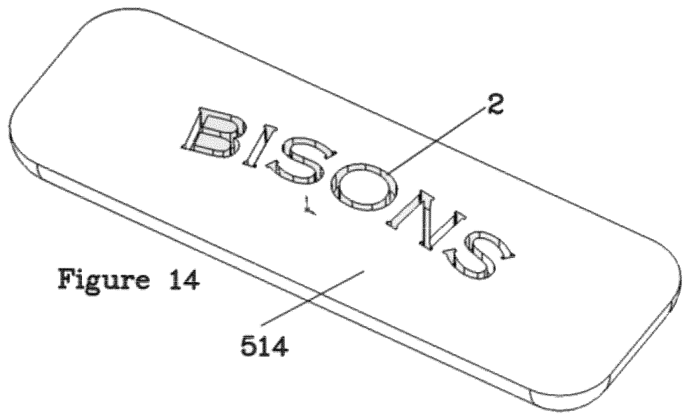

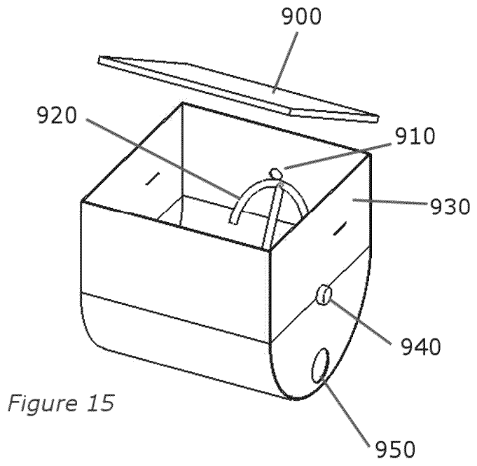

FIG. 14 The condiment keeper, 2, as many embodiments and applications that include but are not limited to the means to keep condiments from running off the substrate (a.k.a. the Flat-Dog), a means to expedite cooking as well as introduce “crunch” into some of the fabric of the Flat-Dog, and finally as an advertising means for the vendor, sports teams, charities, religions and so on.

FIG. 15. An important contribution of this patent is the Smoke-Mixer. Instead of producing a sausage and then smoking at the end of the process, smoking takes place at the beginning while the meat is being mixed allowing for streamlined production. Instead of, as in a Smoker of the Art, making smoke diffuse through a casing and the product body which consumes significant time, smoke can be introduced into a mixer where the smallest particles of meat are exposed to smoke, quickly adding the smoke's positive attributes. All sausage batter requires mixing. The conventional smoking chamber and requisite process delay are thus eliminated Standard mixer means 930 is modified to smoke meat whilst mixing. Meat is placed within 930 and lid 900 is placed atop to seal the vessel. Smoke is introduced through port 910 as defined by recipe. Mixer-blade 920 churns the meat via input-shaft 940. Smoked-meat is removed via port 950 or via the lid 900. A port is provided to remove smoke so a constant-level of smoke may be maintained. Also, a measuring means may be attached to measure the smoke concentration in real-time.

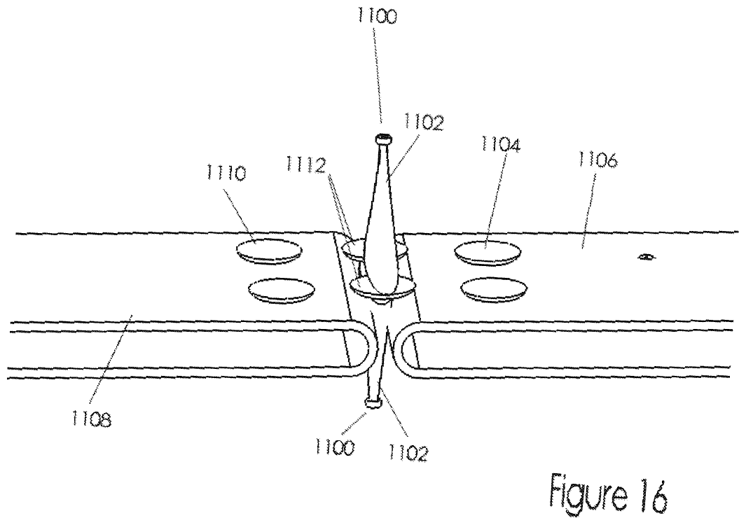

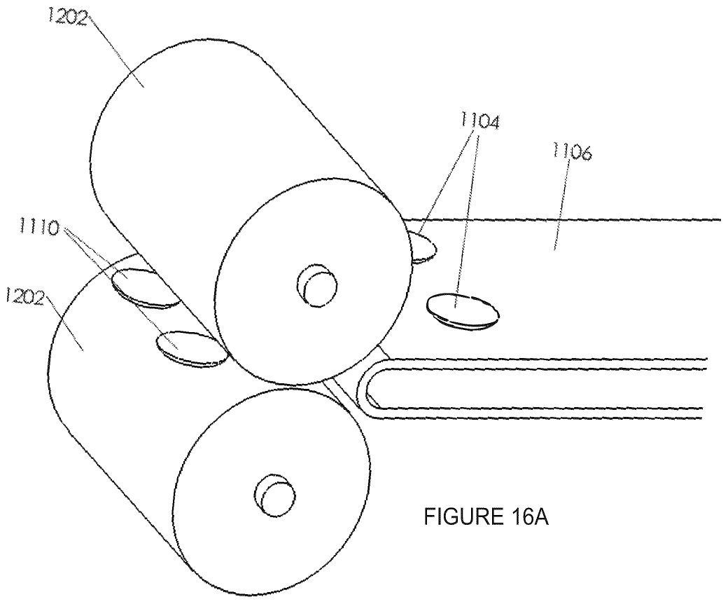

FIG. 16. Illuminates a means for placing a casing on a sausage of any form-factor using a projection of Alginates (or similar) 1102 in the local environment projected from 1100 such that they cover the product 1112. The uncoated product 1104 is conveyed, from right to left, via conveying means 1106. This conveying means can be a conveyor belt of the Art, a stream of air or water, or any means suitable. The spraying-means applies the casing means to both sides of the product simultaneously. 1110 is the product coated with casing on all sides. At any point, an electrostatic charge may be applied to the product to provide for active deposition of the casing material on the product to create a uniform and contiguous coating. Downstream the Flatdog is developed with CaCl₂

FIG. 16a. A similar version of FIG. 16 wherein instead of the particulates suspended or carried by the air, they are contained within a porous reservoir 1202. This application medium has the advantage of reaching around the edges of the product for a more complete coating. There is also less wasted since the applicators are touching each other and the product

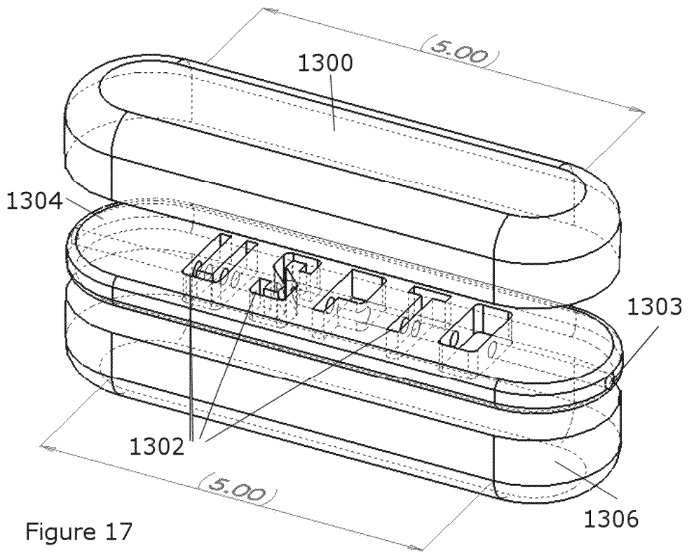

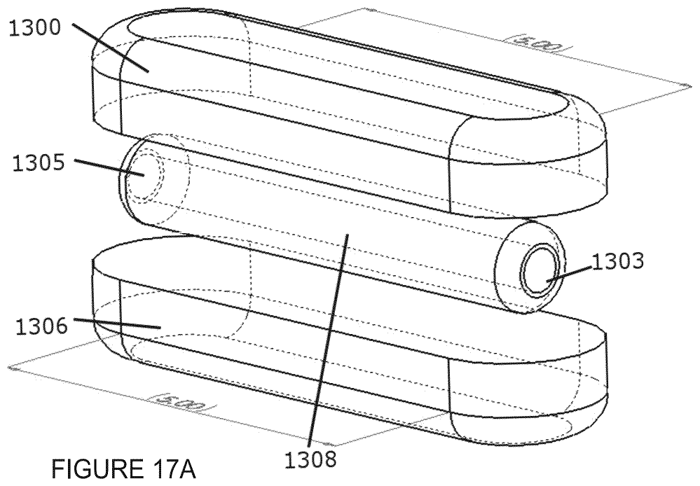

FIG. 17. Illustrates a Flatdog 1304 squarely nested between the top 1300 and bottom 1306 of a hotdog bun of the Art. This minimum embodiment securely traps the hotdog within the bun. The addition of Condiment Keeper 1302 provides an added anchor to the bun further disallowing motion of the sausage. The Condiment Keeper 1302 is trans-sausage, each letter capable of being filled with a different condiment adding further gastronomic delight

FIG. 17a. Demonstrates how a cylindrical hotdog 1305 of the Art can be fitted with a Condiment Keeper internally 1303. The lumen is manufactured in situ during the initial forming process. The Condiment Keeper 1303 orifice is of sufficient gauge to allow the insertion of a nozzle from mustard, catsup or other condiment dispenser of the Art. This orifice is of sufficient gauge to allow the insertion of a secondary meat, cheese or other food item 1308 into and through orifice 1303

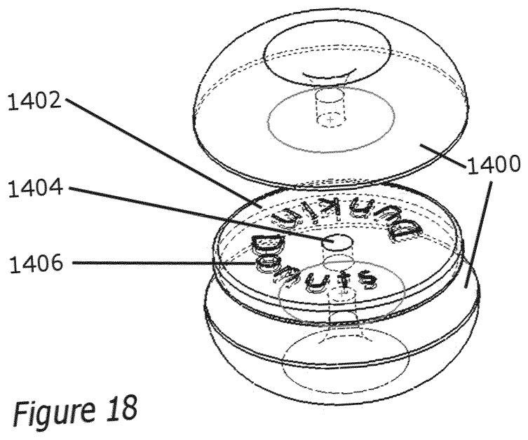

FIG. 18. Depicts a circular Flatdog wherein the Condiment Keeper is comprised of a trans-sausage opening on the center and dimpled-letters depicting the vendor's trademark.

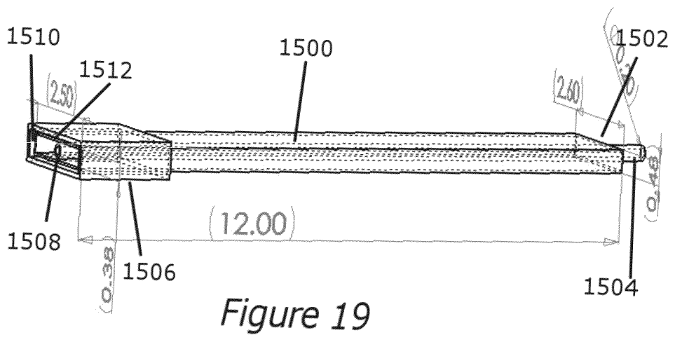

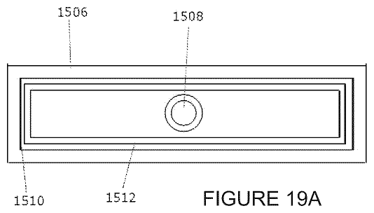

FIG. 19. Elucidates a means 1500 to manufacture a Flatdog with or without a casing including an optional central filling. The optional filling comprising cheese, jalapeno peppers, Cranberry sauce and the like may be placed in the center of the meat product regardless of the use of a casing, Condiment Keepers using port 1504.

The batter is introduced through port 1502; It id under some minimal pressure.

FIG. 19a. Referring to FIG. 19 concurrently, Ejection nozzle 1506 is comprised of the with filling nozzle 1508, casing nozzle 1510 and batter nozzle 1512.

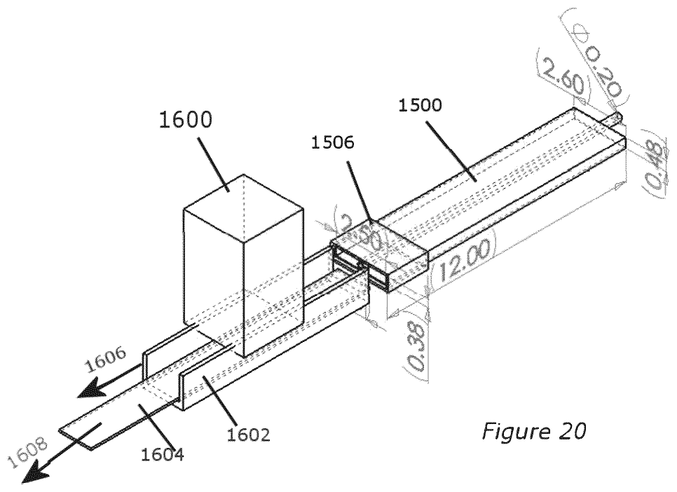

FIG. 20. Demonstrates the forming end of a sausage comprising Central Batter, and/or Casing and/or filling and/or Condiment Keeper.

Trough 1602 contains CaCl₂) solution which is maintained at a functional concentration and pH which completely submerges the sausage produced at 1506. Conveyor Means 1604 draws the sausage through the bath for further processing in the direction of 1608. The trough 1602 continues in the direction of 1606 as the process requires. Condiment Keeper tool 1600 is placed at a point where the batter just begins to firm so when the action is imparted, the shape remains. 1600 can be mechanical, pneumatic, acoustic, gravimetric, electronic or any means capable of imparting a deformation to the batter.

The manufacture of tube-steaks is well known in the Art as emulsion-type sausages. These sausages are comprised of various animal parts, spices, flavor-enhancing additives and water wherein the ingredients are masticated into a fine puree. In order to retain the familiar hotdog appearance, this purse is loaded into a casing for cooking and further processing. This purée may also be comprised of vegetable matter as in the case of tofu tube-steaks or flavored matter that may be gastronomically satisfying but of little to no nutritive value; items to help lose weight. The planar-form-factor hotdog product, if meeting the appropriate standards, could also be Kosher. The actual recipe for the filling is the choice of the producer.

An early attempt U.S. Pat. No. 3,857,330, the process to make a toroidal or bagel form-factor sausage is necessarily discontinuous: the molds must be filled, processed, emptied and then sent for down-steam processing. In an industry that produces >5,100 sausages/line/minute, this would relegate the manifest advantages of this food to a few specialty manufactures and would not enjoy the benefit of mass-production. This shape of U.S. Pat. No. 3,857,330 was chosen “for purposes of shipping and storing.” Claim 1 also specifies a “top and bottom layer,” completely absent in the present invention.

During the production of a hotdog, a meat batter that is comprised of all necessary ingredients is placed into a casing, which may consist of natural (some portion of animal gut) or a synthetic tubing which serves as a container for the stuffing; the synthetic casing is removed later in the process and is found in the production of skinless hotdogs. The natural casing remains a part of the hotdog and is eaten. This casing is historically cylindrical. The present invention provides for a shaped casing that will closely assume the configuration of a flat tube-steak.

Mechanical Flattening: A new method for making a shaped hotdog begins with non-cooked emulsion constrained by a cylindrical casing as is common in the Art. The batter, which typically retains a set form once heated is shaped by applying a force normal to the casing and contents so the entire form is flattened. Heat is applied to the casing/contents either during or immediately after the pressing to modify the meat-emulsion so it retains the flattened shape.

The internal temperature must reach a prescribed minimum as defined by the specific recipe and this temperature may or not need be isothermal across the cross-section of the frank. To this end, the rollers could be heated to partially set the outer portion of the dachshund with subsequent microwave radiation, or other suitable energy, setting the interior.

U.S. Pat. No. 6,326,039 requires that the skinless frank be conveyed on a belt; the present process may use the advantage of gravity, wherein the shape is aided by the tension provided via free hanging frankfurters after roller forming. The roller forms could be inductively heated with additional RF radiation imparted to the wiener.

Heating-after-forming provides the benefit of cooking the hotdog early on in the process and potentially saving energy, steps and hardware. Heat can be provided by a microwave source immediately at or after the flattening roller or press, by using Radio Frequency emitted by the rollers or other means to heat the meat product. The major disadvantage to directly heating the rollers is that or the rate of heat transfer from outside the tube-steak to its interior is determined by the mixture's thermodynamics and may be too slow for as mass-production process.

Choking Prevention: An important improvement of the Present Invention is that of choking prevention. By making it more difficult, by virtue of a form factor wherein an individual's “bite” of hotdog is less than that, that would overly occlude an individual's airway. It appears that two thicknesses of the planar-form-factor available: a) for children younger than 8 year of age, a maximum thickness of 5 mm which may allow 50% airway obstruction at the epiglottis and b) a maximum thickness of 1 cm for adults. The width is not considered since common sense or etiquette cannot be dictated.

This is different from that random, non-scientific embodiment of U.S. Pat. No. 5,069,914 which places a number of random slices in a frankfurter to minimize the choking probability. On a large enough bite, all members of the cross-section would be presented to airway, perhaps packing more hot dog into the small area exacerbating the choking probability. The present invention overcomes the major problem of when a youngster bites into said wiener; the entire cross section is limited when applied to the oral/pharynx.

Condiment Immobilization or Containment: Condiments are a natural addition to hotdogs and many believe that a hotdog is inedible sans condiments. The surface of a wiener is usually cylindrical and smooth with nothing that offers any resistance to the motion of a condiment(s); when the frank is rotated to any position from parallel with the Earth's surface, the condiments will follow the action of gravity and flow off and out of the hotdog (usually into ones lap . . . )

The addition of grooves, which the Inventors call a Condiment Keeper, the condiments are held fast by the walls of the groove and when placed within a bun, trapped by the bread surface and the groove.

This also offers the advantage of placing, and retaining, more condiments upon a hotdog that is possible with the hotdog of the Art.

These groves may also be used to present a shape (manufacturer's logo) or word to the Consumer whilst providing the function described above.

U.S. Pat. No. 4,235,941 describes the addition of grooves to “provide the mere appearance of a charcoal cooked steak.” These grooves do not add to the functional quality of the food-product, or its ability to be cooked more expeditiously. Finally, no mention is made of using these topographical features for any application beyond aesthetics.

Bun Conservation: The flat-dog represents the first improvement of the hot-dog-sandwich wherein both the product and the experience are improved. In earlier embodiments, the bun (bread product specifically designed to receive the hotdog, is typically a (roughly) cylindrical-shaped elongated loaf of bread that is slightly larger than the wiener.) One edge is sliced longitudinally (from a long side inwards) up to, but not through the opposite side. This remaining bread-material constitutes a hinge or the bottom of a trough. When the hotdog (of the Art) is placed within this sliced bun, it is typically rotated 90° such that the tube-steak rests upon the fragile hinge-part and is pointed upwards. Condiments are added at this point.

The added moisture from the condiments is conducted past the wiener and is deposited upon the bread hinge, the thin bottom on the VEE shaped trough that holds the sausage, is dissolved and allows the hotdog to fall through to ones clean clothes or the ground.

The planar shaped sausage or flat-dog (with or without condiment keepers) eliminates the need for the delicate hinge (allowing the complete slicing of the bun, which also saves time in preparation). The condiments are applied to the condiment keeper side of the wiener wherein the bun is placed atop. Gripping the bun by the two sides retains the tube-steak and the condiments are retained by the surface of the bun against the keepers.

Shaped casing: A casing in the general form of FIG. 1a could be filled in the manner consistent with the present Art and processed as a cylindrical hotdog. These casings would be of similar length to what is commonly used in the Art and would require minimal change to existing production lines. The end of the wiener can be twisted-shut as in cylindrical hotdogs of the Art.

Shaped Extrusion: A tube-steak would be extruded into free space or on to a conveyance means with the casing being co-extruded and activated by a chemical or other means, thereby setting the shape into a flattened form. Processing would be as any other hotdog or incorporating improvements cited herein. This would also allow a hotdog to be formed in the same factor as the center area of a hotdog bun.

Master Sausage: A casing the diameter of a finished flat-dog is processed as a production hotdog. The large-diameter casing is then divided into circular flat-dogs of the desired thickness. It is also possible to use the extrusion method to manufacture this master sausage.

Chemical Casing: The Master Sausage or any other Flat Dog embodiment may be chemically treated so further treatment will allow a casing to form on the exterior.

Spray Casing: A casing may be sprayed on the product, as in FIG. 6, 510 developing into a casing.

It should be understood that the preferred embodiment was described to provide the best illustration of the principles of the invention and its practical application to thereby enable one of ordinary skill in the art to utilize the invention in various embodiments and with various modifications as are suited to the particular use contemplated. ⁱ U.S. Pat. No. 4,975,291; http://life.familyeducation.com/slideshow/safety/65468.html#ixzz3HHp44q5d; Schmitters Flatdogs; http://www.health.ny.gov/prevention/injury_prevention/choking_prevention_for_children.htm (J.T.'s Law); Flat Dog LLC—http://flatdoglic.liveonatt.com/aboutflatdog.nxgⁱⁱ http://www.hot-dog.org/media/consumption-stats; “Americans enjoy seven billion hot dogs between Memorial Day and Labor Day,” http://www.berksfoods.com/faq/ⁱⁱⁱ American Academy of Pediatrics (AAP): http://www.aap.org/en-us/about-the-aap/aap-press-room/Pages/Numbers-of-Food-Related-Choking-in-Children-Continue-to-Climb.aspx, Numbers of Food-Related Choking Incidents in Children Continue to Climb and, A Dangerously Tasty Treat: The Hot Dog is a Choking Hazard MEDIA CONTACT: Ekaterina Pesheva EMAIL: epeshev1@jhmi.edu PHONE: (410) 502-9433 http://www.hopkinschildrens.org/A-Dangerously-Tasty-Treat-The-Hot-Dog-is-a-Choking-Hazard.aspx#^{iv} Dave's Hot 'n Juicy ¾ Lb. Triple three-quarters of a pound of 100% real north American beef and more of the fresh premium toppings you crave all on buttered, toasted buns, to keep your hamburger hotter and juicier. (Wendy's)^{v} https://www.youtube.com/watch?feature=player_detailpage&v=2NzUm7UEEIY

What is claimed is:

1. An apparatus comprising: a sausage-like, roughly rectangular planar food-piece, having indentations or graphics on and below the surface.

2. The sausage-like apparatus as in claim 1, wherein the thickness is less than 25% of said width.

3. The sausage-like apparatus as in claim 1, wherein holes, grooves, or indwelling graphics whose presence contain or entrap an applied condiment.

4. The sausage-like apparatus as in claim 1, wherein holes, grooves, or indwelling graphics are present to enhance a connection between the sausage-like apparatus and the bun.

5. An apparatus comprising: a sausage-like, roughly rectangular planar food-piece wherein a passage traverses the interior length.
